(19) United States
(12) Patent Application Publication
(10) Pub. No.: US 2013/0318976 A1
(43) Pub. Date: Dec. 5, 2013

(54) TURBOMACHINE COMBUSTOR NOZZLE AND METHOD OF FORMING THE SAME

(71) Applicants: Patrick Benedict Melton, Horse Shoe, NC (US); Lucas John Stoia, Taylors, SC (US); James Harold Westmoreland, Greer, SC (US)

(72) Inventors: Patrick Benedict Melton, Horse Shoe, NC (US); Lucas John Stoia, Taylors, SC (US); James Harold Westmoreland, Greer, SC (US)

(73) Assignee: GENERAL ELECTRIC COMPANY, Schenectady, NY (US)

(21) Appl. No.: 13/482,584

(22) Filed: May 29, 2012

(51) Int. Cl. F23R 3/28; B23P 11/00; F02C 3/04; F23R 3/10

(52) U.S. Cl. 60/737; 60/742; 29/889.22; 60/805

(57) ABSTRACT

A turbomachine combustor nozzle includes a first plate member having a first plurality of openings, and a second plate member having a second plurality of openings that are configured and disposed to be in alignment with the first plurality of openings. A plurality of nozzle members extends through corresponding ones of the first plurality of openings and the second plurality of openings. Each of the plurality of nozzle members includes a solid core.

### FEDERAL RESEARCH STATEMENT

This invention was made with Government support under Contract Number DE-FC26-05NT42643 awarded by the Department Of Energy. The Government has certain rights in this invention.

### BACKGROUND OF THE INVENTION

The subject matter disclosed herein relates to the art of turbomachines and, more particularly, to a turbomachine combustor nozzle.

In general, gas turbomachines combust a fuel/air mixture that releases heat energy to form a high temperature gas stream. The high temperature gas stream is channeled to a turbine portion via a hot gas path. The turbine portion converts thermal energy from the high temperature gas stream to mechanical energy that rotates a turbine shaft. The turbine portion may be used in a variety of applications, such as for providing power to a pump, an electrical generator, a vehicle, or the like.

In a gas turbomachine, engine efficiency increases as combustion gas stream temperatures increase. Unfortunately, higher gas stream temperatures produce higher levels of nitrogen oxide (NOx), an emission that is subject to both federal and state regulation. Therefore, there exists a careful balancing act between operating gas turbines in an efficient range, while also ensuring that the output of NOx remains below mandated levels.

### BRIEF DESCRIPTION OF THE INVENTION

According to one aspect of the exemplary embodiment, a turbomachine combustor nozzle includes a first plate member having a first plurality of openings, and a second plate member having a second plurality of openings that are configured and disposed to be in alignment with the first plurality of openings. A plurality of nozzle members extends through corresponding ones of the first plurality of openings and the second plurality of openings. Each of the plurality of nozzle members includes a solid core.

According to another aspect of the exemplary embodiment, a method of forming a turbomachine combustor nozzle includes forming a radial passage through corresponding ones of a plurality of nozzle members each having a solid core, arranging the plurality of nozzle members in a corresponding plurality of openings formed in a first plate member, arranging the plurality of nozzle members in another corresponding plurality of openings formed in a second plate member, bonding the plurality of nozzle members to each of the first plate member and the second plate member, and forming a central passage that fluidically connects with the radial passage through the solid core after the plurality of nozzle members are bonded to the first and second plate members.

According to yet another aspect of the exemplary embodiment, a turbomachine includes a compressor portion, a turbine portion operatively connected to the compressor portion, and a combustor assembly fluidically connected to the compressor portion and the turbine portion. The combustor assembly includes a combustor nozzle including a first plate member having a first plurality of openings, and a second plate member including a second plurality of openings that are configured and disposed to be in alignment with the first plurality of openings. A plurality of nozzle members extends through corresponding ones of the first plurality of openings and the second plurality of openings. Each of the plurality of nozzle members includes a solid core.

These and other advantages and features will become more apparent from the following description taken in conjunction with the drawings.

### BRIEF DESCRIPTION OF DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic view of a turbomachine including a combustor assembly having a combustor nozzle in accordance with an exemplary embodiment;

FIG. 2 is a cross-sectional view of the combustor assembly of FIG. 1 illustrating a combustor nozzle in accordance with an exemplary embodiment;

FIG. 3 is a cross-sectional view of the combustor nozzle of FIG. 2;

FIG. 4 is a partial cross-sectional view of the combustor nozzle of FIG. 3 illustrating a solid nozzle element having a pre-drilled radial passage arranged between first and second plates in accordance with an exemplary embodiment; and

FIG. 5 is a partial cross-section view of the turbomachine nozzle of FIG. 4 following a central passage forming process.

The detailed description explains embodiments of the invention, together with advantages and features, by way of example with reference to the drawings.

### DETAILED DESCRIPTION OF THE INVENTION

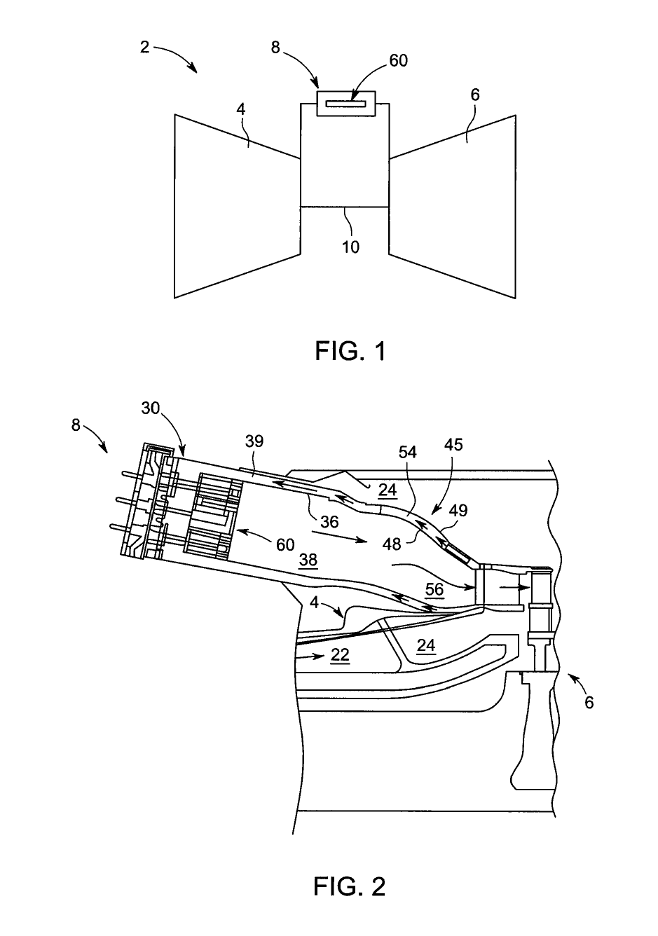

With initial reference to FIGS. 1 and 2, a turbomachine constructed in accordance with an exemplary embodiment is indicated generally at 2. Turbomachine 2 includes a compressor portion 4 connected to a turbine portion 6 through a combustor assembly 8. Compressor portion 4 is also connected to turbine portion 6 via a common compressor/turbine shaft 10. Compressor portion 4 includes a diffuser 22 and a compressor discharge plenum 24 that are coupled in flow communication with each other and combustor assembly 8. With this arrangement, compressed air is passed through diffuser 22 and compressor discharge plenum 24 into combustor assembly 8. The compressed air is mixed with fuel and combusted to form hot gases. The hot gases are channeled to turbine portion 6. Turbine portion 6 converts thermal energy from the hot gases into mechanical rotational energy.

Combustor assembly 8 includes a combustor body 30 and a combustor liner 36. As shown, combustor liner 36 is positioned radially inward from combustor body 30 so as to define a combustion chamber 38. Combustor liner 36 and combustor body 30 collectively define an annular combustion chamber cooling passage 39. A transition piece 45 connects combustor assembly 8 to turbine portion 6. Transition piece 45 channels combustion gases generated in combustion chamber 38 downstream towards a first stage (not separately labeled) of turbine portion 6. Transition piece 45 includes an inner wall 48 and an outer wall 49 that define an annular passage 54. Inner wall 48 also defines a guide cavity 56 that extends between combustion chamber 38 and turbine portion 6. The above described structure has been provided for the sake of completeness, and to enable a better understanding of the exemplary embodiments which are directed to a nozzle assembly 60 arranged within combustor assembly 8.

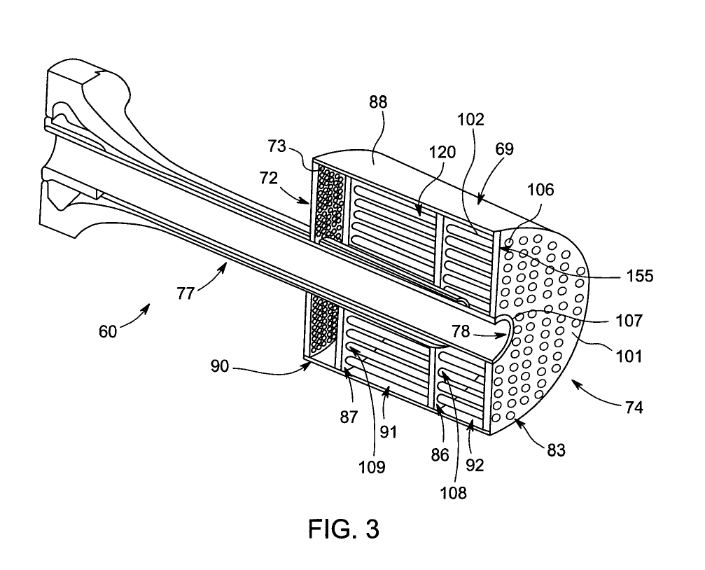

Referring to FIG. 3, nozzle assembly 60 constitutes a fuel cooled nozzle including a nozzle body 69 having a fluid inlet plate 72 provided with a plurality of openings 73. Nozzle body 69 is also shown to include an outlet 74 that delivers a combustible fluid into combustion chamber 38. A fluid delivery passage 77 extends through nozzle body 69 and includes an outlet section 78 that allows for insertion of a cylindrical cartridge (not shown). Nozzle body 69 includes a first or discharge plate member 83, a second or fluid flow conditioning plate member 86 and a third plate member 87 that are joined by an outer nozzle wall 88. At this point it should be understood that fluid flow conditioning plate may be omitted from nozzle assembly 60 in accordance with other aspects of the exemplary embodiment. As shown, fluid inlet plate 72 is spaced from third plate member 87 to define a first fluid plenum 90, third plate member 87 is spaced from fluid flow conditioning plate member 86 to define a second fluid plenum 91, and fluid flow conditioning plate member 86 is spaced from discharge plate member 83 to define a third fluid plenum 92. Discharge plate member 83 includes a first surface section 101 and an opposing second surface section 102. Fluid flow conditioning plate 86 may be provided with a plurality of openings (not shown) that establish a desired pressure of fluid flowing from second plenum 91 into third fluid plenum 92. Discharge plate member 83 is shown to include a first plurality of discharge passages or openings 106 and a central opening 107. Central opening 107 is configured and disposed to receive outlet section 78 of fluid delivery passage 77. Fluid flow conditioning plate member 86 includes a second plurality of openings 108, and third plate member 87 includes a third plurality of openings 109. Fluid flow conditioning plate member 86 and third plate member 87 also include central openings (not separately labeled) that receive portions of fluid delivery passage 77. Nozzle assembly 60 includes a plurality of nozzle members, one of which is indicated at 120 that extend through plate members 83, 86, and 87.

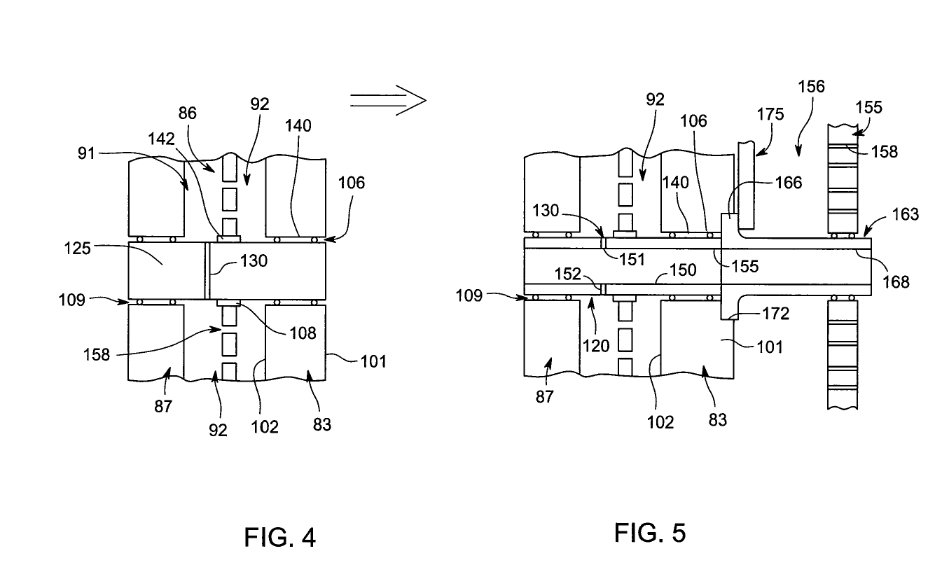

In accordance with an exemplary embodiment illustrated in FIG. 4, nozzle members 120 include a solid core 125 and a radial passage 130. Radial passage 130 is pre-formed in each nozzle member 120 prior to installation to discharge plate member 83, fluid flow conditioning plate member 86, and third plate member 87. Radial passage 130 may be formed using a variety of known techniques including drilling a hole through each nozzle member 120. After forming radial passage 130, nozzle members 120 are inserted into the first plurality of openings 106 formed in discharge plate member 83, the second plurality of openings 108 provided in fluid flow conditioning plate 86, and the third plurality of openings 109 provided in third plate member 87.

Once in position, nozzle members 120 are bonded to discharge plate member 83, fluid flow conditioning plate member 86, and third plate member 87. Nozzle member 120 may be joined to plate members 83, 86, and 87 using a variety of techniques. For example, nozzle members 120 may be joined to discharge plate member 83 by a welded bond 140 and to fluid flow conditioning plate 86 through a welded bond 142. After joining nozzle members 120 to plate members 83, 86, and 87, a central passage 150 is formed through solid core 125 (FIG. 5).

Central passage 150 extends axially an entire length of each nozzle member 120 and fluidically connects with radial passage 130 forming first and second fluid inlets 151 and 152. Central passage 150 includes an inlet (not shown) fluidically coupled to first plenum 90 and an outlet 155 positioned at first surface section 101 of discharge plate member 83. Central passage 150 allows fuel and air to flow from nozzle assembly 60. More specifically, air is introduced the inlet (not shown) of each nozzle members 120 at first plenum 90. Fuel is introduced into third plenum 92. The fuel flows through openings 158 formed in flow conditioning plate member 86 passing into second plenum 91. The fuel enters first and second fluid inlets 151 and 152 and passes into central passage 150 to mix with the air forming a fuel/air mixture. The fuel/air mixture is discharged from outlets 155 at discharge plate member 83 into combustion chamber 38.

Forming radial passage 130 prior to joining nozzle members 90 to plates 83, 86, and 87 leads to various manufacturing benefits. For example, forming radial passages 130 prior to a joining operation allows for a more close packing or density of nozzle members 120 that would otherwise not be possible if radial passages were formed after the joining operation. Of course it should be understood that radial passage 130 may also be formed following joining nozzle members 120 to plate members 83, 86, and 87. In such a case, radial passage 130 may be formed from within central passage 150 employing, for example, an electrical discharge machining or EDM process.

In accordance with another aspect of the exemplary embodiment illustrated in FIG. 5, nozzle assembly 60 may include an additional plate 155 that forms an air plenum 156. Air plenum 156 receives air from annular combustion chamber cooling passage 39 through openings (not shown) formed in nozzle body 69. The air impinges upon additional plate 155 and passes through impingement cooling holes one of which is shown at 158. The air passing through impingement cooling holes 158 provides air cooling to additional plate 156. In this arrangement, nozzle 60 constitutes an air cooled nozzle. Also in accordance with this arrangement, nozzle 60 is provided with a plurality of nozzle extensions, one of which is shown at 163, that project axially outward from first surface section 101. Each nozzle extension 163 includes a first or flanged end 166 that extends to a second or outlet end 168. Flanged end 166 nests within a recess, such as shown at 172, formed in first surface section 101 about each outlet 155. Flanged end 166 is placed within recess 172 and held in place with a clamping plate 175. Clamping plate 175 includes a number of openings (not separately labeled) that are configured to register with and receive each nozzle extension 163. Clamping plate 175 may be joined to discharge plate member 83 using a variety of techniques including a threaded joint, a brazed joint, a welded joint, and mechanical fasteners. Also, it should be understood that clamping plate 175 may be omitted and flanged end 166 joined to first surface section 101 through welding, brazing or other metal joining processes.

At this point it should be understood that the exemplary embodiments describe a nozzle assembly that is formed with nozzle members initially having a solid core. The nozzle members are pre-drilled to form a radial passage and joined to plate members. Pre-drilling the radial passage allows for a more closely packed arrangement of nozzle members. More specifically, pre-drilling the radial passage makes it unnecessary to form inlets in the nozzle members once mounted in a nozzle assembly. Of course, the radial passage could also be formed after mounting to the plates if so desired. The exemplary embodiment also describes forming an axial passage through the solid core. Forming the axial passage after mounting the nozzle members to the plate members allows for the use of faster, and less expensive bonding operations, such as welding, that decrease manufacturing time, costs and complexity. Also, while the axial passage is shown as extending entirely though the nozzle member, other types of passages may also be employed. For example, a plurality of axially offset passages may be drilled or otherwise formed so as to extend partially into the nozzle member. Each of the plurality of axially offset passages are joined through the axial passage. In this arrangement, the axially offset passages induce a swirl to fluids passing through the nozzle member that may enhance mixing.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A turbomachine combustor nozzle comprising:
a first plate member including a first plurality of openings;
a second plate member including a second plurality of openings that are configured and disposed to be in alignment with the first plurality of openings; and
a plurality of nozzle members extending through corresponding ones of the first plurality of openings and the second plurality of openings, each of the plurality of nozzle members including a solid core.

2. The turbomachine combustor nozzle according to claim 1, wherein each of the plurality of nozzle members includes a radial passage that passes though at least a portion of the solid core.

3. The turbomachine combustor nozzle according to claim 2, wherein the radial passage is arranged between the first plate member and the second plate member.

4. The turbomachine combustor nozzle according to claim 2, wherein each of the plurality of nozzle members are joined to the first plate member and the second plate member through a plurality of bonds.

5. The turbomachine combustor nozzle according to claim 4, wherein the plurality of bonds comprise welds.

6. The turbomachine combustor nozzle according to claim 4, wherein each of the plurality of nozzle members is provided with a central passage formed through the solid core after being joined to at least one of the first plate member and the second plate member, the central passage fluidically connecting with the radial passage.

7. The turbomachine combustor nozzle according to claim 6, wherein each of the plurality of nozzle members is provided with the central passage after being joined to each of the first plate member and the second plate member.

8. The turbomachine combustor nozzle according to claim 1, wherein the first plate member includes a first surface section and a second surface section, the first surface section including one or more recesses.

9. The turbomachine combustor nozzle according to claim 8, further comprising: one or more nozzle extensions mounted to the first surface section of the first plate member, each of the one or more nozzle extensions including a flanged end that nests within respective ones of the one or more recesses.

10. The turbomachine combustor nozzle according to claim 9, further comprising: a clamping plate joined to the first plate member, the clamping plate securing the one or more nozzle extensions to the first surface section.

11. A method of forming a turbomachine combustor nozzle, the method comprising:
forming a radial passage through corresponding ones of a plurality of nozzle members each having a solid core;
arranging the plurality of nozzle members in a corresponding plurality of openings formed in a first plate member;
arranging the plurality of nozzle members in another corresponding plurality of openings formed in a second plate member;
bonding the plurality of nozzle members to each of the first plate member and the second plate member; and
forming a central passage that fluidically connects with the radial passage through the solid core after the plurality of nozzle members are bonded to the first and second plate members.

12. The method of claim 11, further comprising: positioning the radial passage between the first plate member and the second plate member.

13. The method of claim 11, wherein bonding the plurality of nozzle members comprises welding each of the plurality of nozzle members to respective ones of the first plate member and the second plate member.

14. The method of claim 11, further comprising:
forming a recess in a surface section of the first plate member; and
installing a flanged end of a nozzle extension in the recess.

15. The method of claim 14, further comprising: clamping the flanged end of the nozzle extension to the surface section of the first plate member.

16. A turbomachine comprising:
a compressor portion;
a turbine portion operatively connected to the compressor portion; and
a combustor assembly fluidically connected to the compressor portion and the turbine portion, the combustor assembly including a combustor nozzle comprising:
a first plate member including a first plurality of openings;
a second plate member including a second plurality of openings that are configured and disposed to be in alignment with the first plurality of openings; and
a plurality of nozzle members extending through corresponding ones of the first plurality of openings and the second plurality of openings, each of the plurality of nozzle members including a solid core.

17. The turbomachine according to claim 16, wherein each of the plurality of nozzle members includes a radial passage that passes through at least a portion of the solid core, the radial passage being arranged between the first plate member and the second plate member.

18. The turbomachine according to claim 17, wherein each of the plurality of nozzle members are joined to the first plate member and the second plate member through a plurality of bonds.

19. The turbomachine according to claim 18, wherein each of the plurality of nozzle members is provided with a central passage through the solid core after being joined to at least one of the first plate member and the second plate member, the central passage fluidically connecting with the radial passage.

20. The turbomachine according to claim 19, wherein each of the plurality of nozzle members is provided with the central passage after being joined to each of the first plate member and the second plate member.
